(19) United States
(12) Patent Application Publication
(10) Pub. No.: US 2004/0162381 A1
(43) Pub. Date: Aug. 19, 2004

(54) Anti-graffiti composition

(76) Inventor: Subir K. Dey, Bridgewater, NJ (US)

Correspondence Address: Sujatha Subramaniam, BRINKS HOFER GILSON & LIONE, P.O. Box 10395, Chicago, IL, 60610, US

(21) Appl. No.: 10/369,239

(22) Filed: Feb. 19, 2003

(51) Int. Cl. C08J 3/00

(52) U.S. Cl. 524/474; 524/543

(57) ABSTRACT

The present invention is generally directed towards an anti-graffiti composition. More particularly to an anti-graffiti composition composed substantially of a polymer and including mineral oil. The mineral oil is present in an amount sufficient to impart anti-graffiti properties to the composition.

### TECHNICAL FIELD OF THE INVENTION

This invention generally relates to an anti-graffiti composition for a polymeric article. More specifically, to an anti-graffiti composition composed substantially of polymer and a secondary compound that repels graffiti.

### BACKGROUND

Today, more and more articles are being manufactured using polyolefin. Such polymeric products exhibit high resistance to breakage, scratch, temperature resistance etc. However, products made from polyolefin are very susceptible to marking using ink, paint etc. It is also very difficult to remove such markings from the surface of such articles.

Graffiti is a common problem encountered in areas of access to the general public for example, walls of a public restroom or portable restrooms or in a subway station. Moreover, generally, unwanted markings on surfaces can occur almost anywhere. Graffiti is often in the form of paint, such as spray paint, but graffiti and other markings may be applied by markers, crayons, and other writing fluids. As used herein, the term “graffiti” will be used to refer broadly to unwanted markings, whether consisting of paint, such other fluids or other unwanted markings, scuff marks and the like.

Such markings are particularly troublesome because they are often very difficult to remove from the surfaces on which they have been applied. Thus, painted surfaces often must be repainted to cover up the markings and sometimes must be even stripped and then repainted. For example, graffiti often is applied with paint similar to that on the surface. Removal of the graffiti paint by abrasion or with a solvent therefore is impractical because it typically results in removal of at least a portion of the underlying paint. Unpainted surfaces sometimes must be sandblasted to remove the markings.

Other solutions also include coating the surface of the article that would serve as a barrier to permit easy removal of such markings. Or coating the surface that may be resistant to graffiti. However, such solutions are expensive and labor intensive. Additionally not all surfaces can be coated with graffiti-resistant coating.

Therefore, there is a need to have a new anti-graffiti composition which is resistant to graffiti and does not have a need for any external coating.

### SUMMARY

In one aspect of the present invention, an anti-graffiti composition having anti-graffiti properties is disclosed. The anti-graffiti composition has 0.01% to 10% by weight of hydrocarbon and the balance by weight of a High Density Polyethylene compound.

In yet another aspect of the present invention a method of making the anti-graffiti composition having anti-graffiti properties is disclosed. The method comprises mixing hydrocarbon to HDPE and extruding the blend to form articles which are repellent to graffiti.

### DETAILED DESCRIPTION

The following description of the preferred embodiment is merely exemplary in nature and is in no way intended to limit the invention or its application or uses.

An anti-graffiti composition is generally disclosed in the present invention. The anti-graffiti composition is particularly useful in manufacturing articles that are intended to be used in the public at large. One such use of the anti-graffiti composition is in the manufacture of portable restrooms. Typically portable restrooms as the name suggests are installed in events that involve a number of people. Although the use of the anti-graffiti composition in manufacturing portable restrooms is only one such example, the anti-graffiti composition of the present invention may be used to manufacture a number of articles such as play room equipment, chairs, tables etc.

The anti-graffiti composition of the present invention is composed of substantially a polymer compound. The amount substantially as used herein is above 90% by weight of the polymer compound. The anti-graffiti composition also includes a secondary compound such as liquid hydrocarbon, preferably mineral oil, mixed with the polymer compound. Although not limited to this theory, it is the theory of the inventors that polymer acts as a reservoir for the liquid hydrocarbon. Therefore when an article is formed using the anti-graffiti composition the core of the article hold the liquid hydrocarbon and the liquid hydrocarbon migrates very slowly to the surface, making the surface ink repellant. When the surface of the article is wiped or washed, the surface concentration of the hydrocarbon oil is reduced and the concentration difference between the core and the surface results in more hydrocarbon oil migrating to the surface, making the surface ink repellant.

The polymer compound used in the present invention is preferably a polyolefin compound, where the polyolefin compound is a High Density Polyethylene (HDPE) having a density in the range from about 0.94 to about 0.98 g/cc. As disclosed above, the anti-graffiti composition of the present invention is composed substantially of HDPE. Preferably, the amount of HDPE present in the final composition is in the range of 90% to 99.95% of HDPE. It is further preferred that the HDPE used in the present invention lends itself to blow molding, injection molding, film molding, thermoforming and extruding process to manufacture the final product. The HDPE used in the present invention is virgin HDPE. Alternately, regrind HDPE may also be used to form the anti-graffiti composition.

In order to obtain the anti-graffiti composition, the HDPE is mixed with a secondary component such as mineral oil. Preferably, mineral oil is present in an amount from about 0.01% to about 10% by weight of the anti-graffiti composition. More preferably, the mineral oil is present in an amount of about 1% to about 5% by weight of the anti-graffiti composition. The mineral oil used in the present invention is a hydrocarbon or a substituted hydrocarbon which is liquid at room temperature, preferably saturated aliphatic and alicyclic non-polar hydrocarbons. Additionally, the mineral oil used in the present invention must be liquid at room temperature and have a boiling point of greater that 230 C such that it does not evaporate when added to molten HDPE and is retained in the HDPE in high temperatures.

Products manufactured from the present anti-graffiti composition are exposed to rigorous and varied environments. For example, such products may require stability in an outdoor environment and therefore, in order to enhance these properties, the anti-graffiti composition may also include specific additives. Such additives may include pigments and dyes for color. Colorants may be added for aesthetic or marketing purposes, but are also used as stabilizers. Dark colors contribute to opacity in a product that can reduce material degradation by sunlight. Additional additives may include fillers for opacity; antioxidants for short-term stability; ultraviolet (UV) stabilizers for weather resistance or processing aids. The various additives are available in different forms are typically added with the polyolefin.

The anti-graffiti properties of the composition are tested by marking the surface of an article formed with ink, paint and markers and allowed to dry for 24 hrs. The marked surface is then wiped clean using a washcloth or an ordinary paper towel. The anti-graffiti properties are measured by “DRY ERASE INDEX”, which is defined as the amount of impression that remains on the surface of the article. A DRY ERASE INDEX of 10 means that the ink or paint can not be wiped dry from the surface and the DRY ERASE INDEX of zero means that no visible residual ink or paint remains on the surface when the surface is wiped dry.

The present invention also discloses a process of producing the anti-graffiti composition. Preferably, the process includes the steps of heating the polyolefin to a desired temperature and adding mineral oil. The resulting mixture was either extruded or injected molded into a sample sheet.

The present invention also discloses a process of testing the anti-graffiti properties. The properties were tested by marking the surface with permanent markers and or paints. Preferably, commercially available marker pens sold under the trademark Rub-A-Dub Laundry manufactured by The marked surface was allowed to sit for about 24 hrs and the mark was erased using a paper towel and/or wash cloth.

The following examples will serve to illustrate the invention:

### EXAMPLE NO: 1

### COMPARATIVE EXAMPLE

Pellets of Polyolefin were melted at 180 C. The polyolefin was pressed to a ¼ inch thick sheet using compression molding press. The sheet was allowed to cool to room temperature.

Following permanent marker pens were used to write on the surface: a) Marker Pen sold by Sanford under the trademark Rub-A-Dub® Laundry marking pen; b) Marker Pen sold by Sanford under the trademark Sharpie®; c) marker pen sold by Avery under the trademark Marks-A-Lot®; d) 3 different colors of Marker Pen sold by Sanford under the trademark Expo® dry erase; e) 4 different colors of markers sold by Sanford under the trademark Deluxe™ Permanent Marker; f) Marker pen commercially available as Bic Brite Liner Highlighters (BL11 yellow). The marked surface was allowed to dry for 24 hrs. An attempt was made to erase the marks with a dry paper towel. The marks could not be wiped off the surface resulting in a DRY ERASE INDEX of 10.

### EXAMPLE 2

Polyolefin regrind, particularly HDPE was melted at 180 C. 10% by weight of the mineral oil commercially available from Aldrich, having a sp. gr. 0.872 and Viscosity 64.8 cs, was mixed with the HDPE in a C. W. Brabender Batch Mixer for 5 minutes. The resulting composition composed of substantially HDPE and 10% by weight of mineral oil was pressed into a ¼ inch thick sheet using a compression molding. The sheet was allowed to cool down at room temperature. The surface was marked using the marker pens listed above. The surface was allowed to dry for 24 hrs and the surface was rubbed in an attempt to erase the marks. It was found by the inventor that no residue or impression of ink remained in the surface of the sheet resulting in a DRY ERASE INDEX of 0.

### EXAMPLE 3

The above Example 2 was used to process the anti-graffiti composition. Like the above example, the resulting compositing was pressed into a sheet using the compression molding press. However, in this example, the surface of the sheet was sprayed with an acrylic paint. Surface was wiped after 24 hrs. It was found by the inventor that the paint could be wiped off using a paper towel resulting in a DRY ERASE INDEX of 0.

### EXAMPLE 4

Mineral oil was mixed into same HDPE, as in Example 2. The amount of mineral oil was in an amount between 5% by weight and 10% by weight. The mineral Oil and HDPE were mixed using a 34 mm co-rotating twin-screw extruder. The resulting composition was extruded through a rod die, cooled in 10 ft. long water trough and pelletized. The pelletized material was re-extruded through a 3″ wide sheet die using the same machine, casted on chilled roller and rolled on paper core. The same anti-graffiti test as Examples 2 & 3 was conducted resulting in the same observations and results as in Examples 2 & 3, also resulting in a DRY ERASE INDEX of 0.

### EXAMPLE 5

10% by weight mineral oil of Example 2, was mixed into Fortiflex (additive) G50-100 HDPE supplied by Solvay using a 34 mm co-rotating twin-screw extruder. The compounded material was extruded through a rod die, cooled in 10 ft. long water trough and palletized. Injection molded ASTM test bars were produced from this composition containing 10% mineral oil. Injection molded ASTM test bars were also produced from compound containing 5%, 2%, 1%, 0.5% and 0.1% mineral oil, produced by dry mixing the 10% mineral oil containing compound and virgin resin at a desired ratio. The same anti-graffiti test as Example 2 was conducted resulting in the same observations as in Example 2. This also resulted in a DRY ERASE INDEX of 0.

### EXAMPLE 6

4% by weight of a colorant was added to the composition described in Example No 5. The same anti-graffiti test as Example 2 was conducted resulting in the same observations as in Example 2.

As seen form the above in Examples 2 to 6, the composition contained mineral oil in different proportions and it resulted in a DRY ERASE INDEX of 0. As compared to Example 1 where the composition contained no mineral oil, thereby resulting in a DRY ERASE INDEX of 10.

As any person skilled in the art will recognize from the previous description and from the figures and claims, modifications and changes can be made to the preferred embodiment of the invention without departing from the scope of the invention as defined in the following claims.

What is claimed is:

1. An anti-graffiti composition composed:
substantially of polymer; and
including 0.01% to about 10% by weight of a mineral oil, the mineral oil being present in an amount to impart anti-graffiti properties to the composition.

2. The anti-graffiti composition of claim 1 wherein the mineral oil is present in an amount between 1% to 5% by weight.

3. The anti-graffiti composition of claim 1 wherein the polymer is present in an amount of 90% to 99.9% by weight.

4. The anti-graffiti composition of claim 1 wherein the polymer is a polyolefin compound.

5. The anti-graffiti composition of claim 4 wherein the polyolefin compound is HDPE.

6. The anti-graffiti composition of claim 1 wherein the mineral oil is a hydrocarbon or a a substituted hydrocarbon.

7. The anti-graffiti composition of claim 1 wherein the mineral oil is a saturated aliphatic and alicyclic non-polar hydrocarbon.

8. The anti-graffiti composition of claim 1 further comprising upto 4% of an additive.

9. The anti-graffiti composition of claim 8 wherein the additive is colorant, anti-oxidant or UV stabilizer.

10. An article having an anti-graffiti surface, the article comprising:
a substantial amount of polymer; and
0.01% to 10% by weight of mineral oil, wherein the mineral oil being present in an amount to impart anti-graffiti properties to the article.

11. The article of claim 10 wherein the mineral oil is present in an amount between 1% to 5% by weight.

12. The article of claim 10 wherein the polymer is present in an amount of 90% to 99.9% by weight.

13. The article of claim 10 wherein the polymer is a polyolefin compound.

14. The article of claim 13 wherein the polyolefin compound is HDPE.

15. The article of claim 10 wherein the mineral oil is a saturated aliphatic and alicyclic non-polar hydrocarbon.

16. The article of claim 10 wherein the mineral oil is a hydrocarbon or a substituted hydrocarbon.

17. The article of claim 10 further comprising upto 4% of an additive.

18. The article of claim 17 wherein the additive is colorant, anti-oxidant or UV stabilizer.

19. An anti-graffiti composition composed:
substantially of polymer; and
a liquid hydrocarbon, such that the liquid hydrocarbon has a Dry Erase Index of less than five, wherein the liquid hydrocarbon is present in an amount to impart anti-graffiti properties.

20. The anti-graffiti composition of claim 19 the liquid hydrocarbon is a substituted hydrocarbon.

21. The anti-graffiti composition of claim 19 wherein the liquid hydrocarbon is mineral oil.

22. The anti-graffiti composition of claim 19 wherein the amount of liquid hydrocarbon is 0.05% to 10% by weight of the anti-graffiti composition.

23. The anti-graffiti composition of claim 19 wherein the polymer is a polyolefin.

24. The anti-graffiti composition of claim 19 wherein the polyolefin is HDPE.
